(19) United States
(12) Patent Application Publication
(10) Pub. No.: US 2012/0254751 A1
(43) Pub. Date: Oct. 4, 2012

(54) APPARATUS AND METHOD FOR PROCESSING SOUND SOURCE

(75) Inventor: Jeong-Hoon KIM, Gyeongsangbuk-do (KR)

(73) Assignee: SAMSUNG ELECTRONICS CO., LTD., Gyeonggi-Do (KR)

(21) Appl. No.: 13/428,428

(22) Filed: Mar. 23, 2012

(30) Foreign Application Priority Data
Mar. 30, 2011 (KR) 10-2011-0029114

(51) Int. Cl. G06F 3/16; G06F 3/048

(52) U.S. Cl. 715/716

(57) ABSTRACT

A sound source is processed in a touch screen electronic device. A representation of the sound source in a touch screen area is displayed. The sound source is reproduced via a first player among a predetermined number of players in the electronic device. A multi-touch operation in the touch screen area is detected, and in response, reproduction of the sound source is repeated via a second, allocated player, while the sound source is still being reproduced via the first player. The repeated reproduction via the second player can result in the generation of a natural, enhanced sound effect.

### CLAIM OF PRIORITY

This application claims priority under 35 U.S.C. §119(a) to a Korean Patent Application entitled “Apparatus and Method for Processing Sound Source” filed in the Korean Intellectual Property Office on Mar. 30, 2011 and assigned Serial No. 10-2011-0029114, the contents of which are incorporated herein by reference.

### BACKGROUND

1. Technical Field

This disclosure relates to an apparatus and a method for processing a sound source.

2. Description of the Related Art

Currently, portable audio players, smartphones, tablet devices, etc. running with various platforms including Bada®, Android® and the like may include computer-generated music programs (i.e., applications or “apps”) for reproducing and mixing pre-stored sounds and musical notes to generate a melody. For instance, an application may be tailored for a specific instrument such as a drum-set capable of producing several types of sound sources (e.g., snare, hi-hat, base, crash, etc). In a typical arrangement, the audio of each sound source is output to a dedicated “player” which is a signal processing software module that processes the audio data by means of decompression and other algorithms. The processed audio data from all the players is then provided to an audio mixer which outputs synchronized audio of all the sound sources.

Current devices typically employ up to 10 players for an application, and since each sound source is matched to a player, the number of sound sources which can be output is limited to a maximum of 10. Due to this limit, it is difficult to output various sound sources on an identical sequence.

For example, when an application such as playing the drum is made, 10 sound sources which can be reproduced by 10 players, can be registered. One of the 10 sound sources can be reproduced as background music, and only the remaining nine sound sources can be reproduced as sound sources related to various drums (e.g., snare, hi-hat, etc).

Moreover, with current applications it is difficult to maintain the effect of the actual spread of a sound source (e.g., maintaining a long duration note).

### SUMMARY OF THE INVENTION

Disclosed is an apparatus and a method for processing a sound source, by which the performance of processing a sound source can be improved.

In an exemplary embodiment, a sound source is processed a touch screen electronic device. A representation of a sound source in a touch screen area is displayed. The sound source is reproduced via a first player among a predetermined number of players in the electronic device. A multi-touch operation in the touch screen area is detected, and in response, reproduction of the sound source is repeated via a second, allocated player, while the sound source is still being reproduced via the first player.

Embodiments of the disclosure, by reproducing a sound source via both first and second players, can result in the generation an enhanced, natural sound effect.

Another aspect of the present disclosure is to provide an apparatus and a method for processing a sound source, by which it is possible to register sound sources, which can be reproduced in a performance mode, without limitation in the number of the sound sources.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a block diagram illustrating the configuration of a portable device according to an exemplary embodiment;

FIG. 2 is a flowchart illustrating a method for processing a sound source by a portable device according to an exemplary embodiment;

FIG. 3A shows an example display screen and illustrates player allocation for explaining the method illustrated in FIG. 2;

FIG. 3B depicts example display screen icons for selecting sound sources within a sound source group; and

FIG. 3C illustrates an example of sound source repeated reproduction according to an embodiment.

### DETAILED DESCRIPTION

Hereinafter, exemplary embodiments of the present disclosure will be described in detail with reference to the accompanying drawings. It should be noted that, in the accompanying drawings, the same elements will be designated by the same reference numerals throughout the following description and drawings although they may be shown in different drawings.

As used herein, “reproducing a sound source” refers to an operation by which a processing element such as a “player” converts audio data representing a sound source to a further digital form. The further form can be either an interim form or a final form suitable for output to a D/A converter and transducer for immediate audible reproduction. An interim form is a form following an interim stage of audio processing, e.g., a decompression stage, which is then output to another audio processing element for final processing.

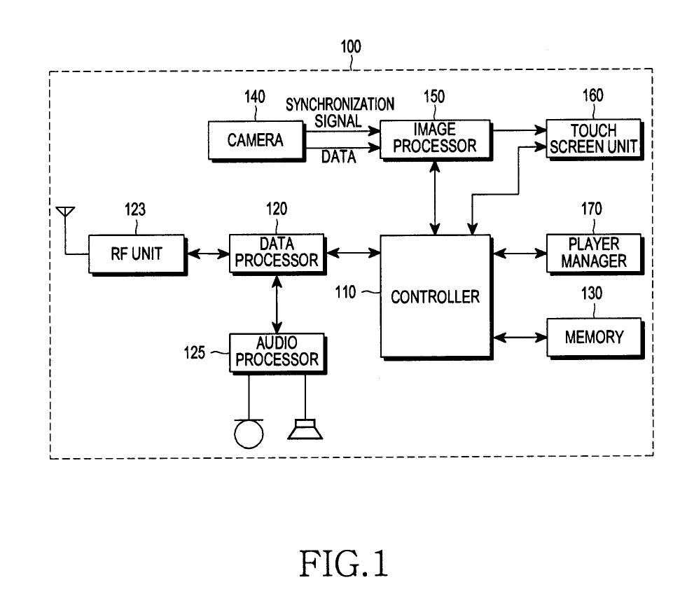

FIG. 1 is a functional block diagram illustrating the configuration of a portable device, 100, according to an exemplary embodiment of the present disclosure. Briefly, a memory 130 stores a plurality of sound sources and a plurality of player modules (“players”), where each player reproduces sound from one or more sound sources.

Sound sources are selectable for reproduction by a user via display selections on a touch screen unit 160. A player manager 170 allocates players for sound source reproduction. In response to a first touch input, a selected sound source is reproduced by a first player such as a default player. While the sound source is reproduced via the first player, if a subsequent one or more touch inputs is detected for the same sound source, a second player is allocated by the player manager 170 to repeat the reproduction of the sound source (one or more times of subsequent reproduction). In this manner, an overall natural sound effect is produced that “carries” with time. An RF unit 123 performs a wireless communication function of the portable device 100. The RF unit 123 includes an RF transmitter for upconverting the frequency of a signal to be transmitted and then amplifying the frequency-upconverted signal, an RF receiver for low-noise amplifying a received signal and then downconverting the frequency of the low-noise amplified signal, etc. A data processor 120 includes a transmitter for encoding and modulating a signal to be transmitted, a receiver for demodulating and decoding a signal received by the RF unit 123, etc. To this end, the data processor 120 may include a modem (modulator/demodulator) and a codec (coder/decoder). The codec includes a data codec for processing packet data and the like, and an audio codec for processing audio signals including voice and the like. The audio processor 125 reproduces a received audio signal, which has been output from the audio codec of the data processor 120, or transmits an audio signal to be transmitted, which is generated from a microphone, to the audio codec of the data processor 120. The audio processor also receives and further processes pre-processed signals received from the plurality of players reproducing sound sources, to be described further.

A memory 130 may include a program memory and a data memory. The program memory may store programs for controlling a general operation of the portable terminal.

Further, according to an exemplary embodiment, the memory 130 may store programs for performing a control operation for repeatedly reproducing a sound source. The repeated reproduction may be responsive to a multi-touch operation to a touch screen area having a representation of the sound source in a performance mode. The repeated reproduction can be implemented through the operation of variably allocating a predetermined number of fixed players for audio processing, and later cancelling the allocation thereof when the repeated reproduction is completed.

Memory 130 additionally stores multiple sound sources which can be reproduced in the performance mode according to an embodiment. The multiple sound sources have a default player which is set as a relevant player among a predetermined number of players. The multiple sound sources may be set as a group in such a manner that the multiple sound sources are matched with multiple small areas included in a relevant area selectable via touch input in a performance mode.

The controller 110, which controls an overall operation of the portable terminal, comprises one or more processors.

The controller 110 may perform a control operation for registering multiple sound sources, which can be reproduced in a performance application mode, without limitation of the number of sound sources (beyond practical memory capacity of the device 100). Also, the controller 110 may perform a control operation for setting each of the multiple sound sources in such a manner that each of the multiple sound sources is matched with an area of a corresponding musical instrument selectable for sound reproduction. Multiple small sub-areas in a group for different aspects or types of the musical instrument may be set forth, with each sub-area selectable for sound reproduction via touch input.

In some implementations, controller 110 perform a control operation for designating a relevant player among a predetermined number of fixed players for reproducing sound sources, as a default player for each of the multiple sound sources. A default player can also be designated for each of a number of groups including the multiple sound sources.

In some implementations, when a multi-touch operation to a common area of a group has occurred in the performance mode, the controller 110 determines whether one or more small areas of the group has been selected via touch input If so, the controller 110 responds with a control operation for repeatedly reproducing a relevant sound source corresponding to each small area selected. The repeated reproduction can be done via the default player and the at least one player allocated by the player manager 170. The player manager 170 identifies information on sound sources for which a default player is designated.

In some implementations, the player that is allocated as a second player for repeated reproduction of a first sound source, can also be a player that is designated as a default player for one or different sound sources, but which is not currently performing a reproduction operation. In other implementations, a single player such as an allocated player can simultaneously handle reproduction operations from several sources. A single player does process audio data from one sound source while it is idle.

Further, when the player manager 170 is notified by the controller 110 that multiple reproductions of a sound source have been completed, the player manager 170 can cancel the allocation of that player for the multiple reproductions, excluding the default player.

The device 100 can include a camera 140, which includes a camera sensor for capturing image data and converting the captured light signal to an electrical signal, and a signal processor for converting the analog image signal, which has been captured by the camera sensor, to digital data. The camera sensor can be, e.g., a CCD (Charge-Coupled Device) sensor or a CMOS (Complementary Metal-Oxide Semiconductor) sensor, and the signal processor may be implemented by using a DSP (Digital Signal Processor). The camera sensor and the signal processor may be implemented as one unit, or may be implemented as separate elements.

The image processor 150 performs ISP (Image Signal Processing) for displaying an image signal, which has been output from the camera 140, by touch screen unit 160. “ISP” refers to the execution of functions including a gamma correction, an interpolation, a spatial change, an image effect, an image scale, AWB (Auto White Balance), AE (Auto Exposure), AF (Auto Focus), etc. Therefore, the image processor 150 processes the image signal, which has been output from the camera 140, on a frame-by-frame basis, and outputs the frame image data in such a manner as to meet the characteristics and the size of the touch screen unit 160. Also, the image processor 150 includes an image codec, and compresses the frame image data displayed by the touch screen unit 160 in a set scheme, or restores the compressed frame image data to an original frame image data. In this case, the image codec may be implemented by using either a JPEG (Joint Photographic Coding Experts Group) codec, an MPEG-4 (Moving Picture Experts Group-4) codec, a Wavelet codec, or the like. Image processor 150 includes an OSD (On-Screen Display) function, and may output on-screen display data according to the size of a screen displayed under the control of the controller 110.

The touch screen unit 160 operates as both a display unit and an input unit. When operating as the display unit, the touch screen unit 160 displays an image signal, which is output from the image processor 150, on a screen thereof, and displays user data, which is output from the controller 110, on the screen. Also, when operating as the input unit, the touch screen unit 160 may display keys for inputting numbers and text information and function keys for setting various functions.

In some implementations, the touch screen unit 160 displays types of musical instruments which can be played in a performance mode.

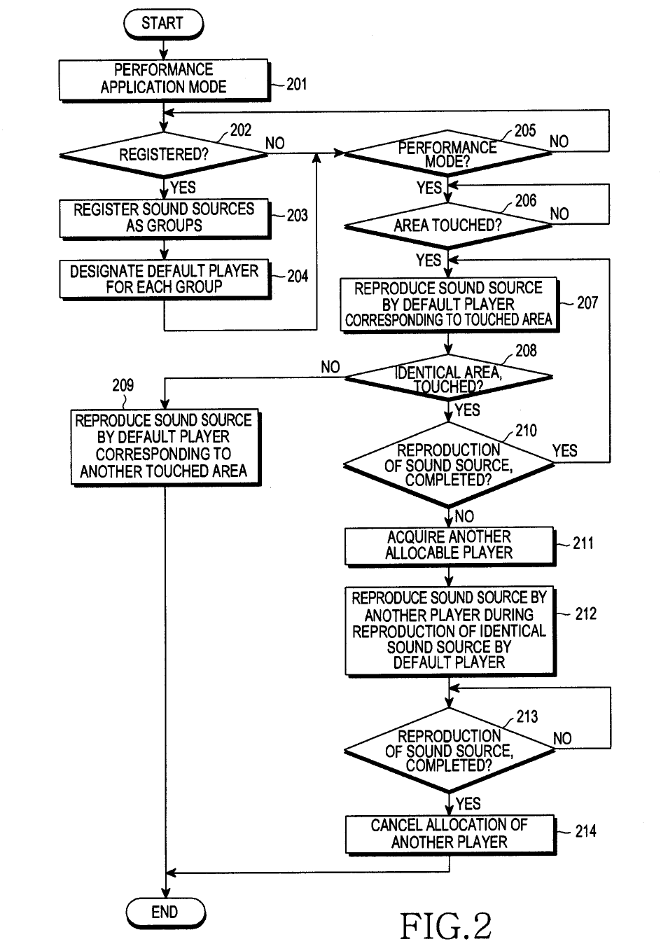

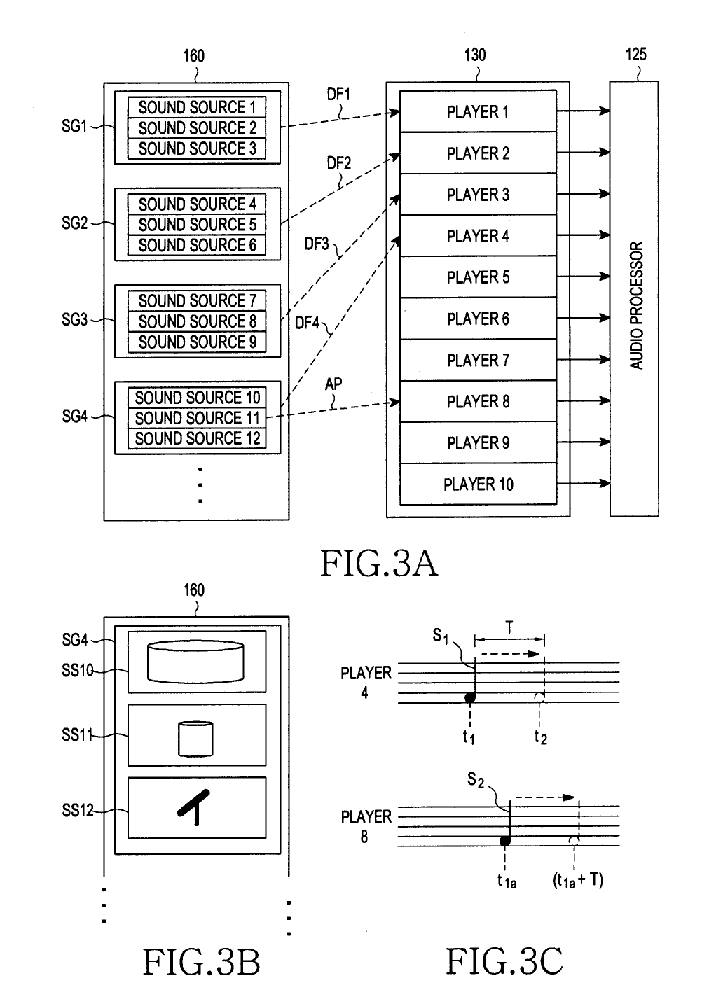

FIG. 2 is a flowchart illustrating a method for processing a sound source by the portable device 100 of FIG. 1 according to an exemplary embodiment. FIG. 3A shows an example display screen and illustrates player allocation for explaining the method of FIG. 2. FIG. 3B depicts a group of example sound source icons and FIG. 3C illustrates an example of sound source repeated reproduction.

Referring collectively to FIGS. 2 and 3(A-C), with reference to FIG. 1, when registration is selected in step 201 corresponding to a performance application mode, the controller 110 senses the selection of the registration in step 202, and then proceeds to step 203. In step 203, under the control of the controller 110, multiple sound sources stored in the memory 130 are set as groups corresponding to areas for reproducing sound sources in a performance mode.

In step 203, each of a number of areas for reproducing sound sources through a touch operation in the touch screen unit 160 in the performance mode may be divided into multiple small areas. Therefore, one group can be designated for one area; and this one area can be subdivided into multiple small areas. This display scheme is illustrated in FIG. 3A, in which sound groups SG1, SG2, SG3 and SG4 are depicted in designated areas of the display screen 160. Any group such as SG4 includes multiple sound source selections such as sound source 10 through sound source 12. A suitable representation of each sound source is displayed in each small sub-area. The representation can be via text, as shown in FIG. 3A.In the performance mode, various musical instruments may be displayed by the touch screen unit 160. For example, a displayed drum may be used to reproduce different sound sources according to touched areas. Therefore, by dividing the drum area into multiple small areas, a sound source corresponding to a touched small area may be reproduced. An example of this display arrangement is shown in FIG. 3B, which depicts sound group SG4 as a drum group. Sound source SS10 is a bass drum and is represented as such; sound source SS11 is a higher pitch drum; sound source SS12 is a symbol. Many other examples are of course possible; any given sound source group can be subdivided into a multiplicity of sound sources with an associated icon or other information item. In addition to different instruments, individual sound sources can be designated for different notes, chords, sequences, etc. of an instrument or set of instruments.

With continuing reference to FIG. 2, Ii step 203, after the multiple sound sources are set as groups corresponding to areas for reproducing sound sources in the performance mode, the controller 110 proceeds to step 204 where a relevant player among a predetermined number of fixed players is designated as a default player for each group. An example designation of default players is illustrated in FIG. 3A, where PLAYER 1 is designated a default player for sound group SG1, as depicted by path DF1. PLAYERS 2 to 4 are designated as default players for sound groups SG2 to SG4, as illustrated with paths DF2 to DF4, respectively.

In step 204, when a default player has been designated for each group, the controller 110 delivers the information on the designation of the default player for each group to the player manager 170. The player manager 170 then recognizes each group including multiple sound sources, for which a player has been designated as a default player. It is noted here that as an alternative to designating default players for each sound source or group or sound sources as described herein, controller 110 can alternatively select an available player randomly or otherwise to handle audio processing (sound reproduction) each time a sound source is selected by a user for reproduction. In other words, default players per se need not be designated to implement some embodiments.

With default players registered at 204 or no additional registration selected at 202, if the controller 110 senses the selection of the performance mode in step 205, and thereafter detects whether a touch input is received (step 206). When a sound source area such as SS10 on the display screen has been selected via touch input in the performance mode, the controller 110 senses the touch input to the area in step 206, and then proceeds to step 207. In step 207, under the control of the controller 110, a sound source corresponding to the touched area is reproduced by a default player corresponding to the touched area. More specifically, the player manager managing the players instructs to operate the default player of the corresponding sound source designated in a register procedure or operate the other player which is not performing the reproducing operation for multiple reproducing the corresponding sound source.
the player manager 170 allocates a default player designated for reproducing a sound source corresponding to the touched area, and the controller 110 controls the default player so as to reproduce the sound source corresponding to the touched area.

At this time, when a touch to an area, where the relevant musical instrument is displayed, has occurred in step 207, the controller 110 determines whether the touched area such as SG4 is divided into multiple small areas such as SS10, SS11 and SS12. If so, the controller 110 determines whether there is a touch-selected small area among the multiple small areas. (Note that in some implementations, a general instrument group such as SG4 may be touch-selected without actually selecting a sub-group within the group. In this case, a default sound for the group can be generated.) If yes, a relevant sound source corresponding to the small area, for which the designation of the default player has been made, is reproduced by the default player.

In step 207, reproduction of the sound source is performed for a predetermined time duration, which may be fixed or variable depending on the instrument, chord, note, etc. Before this time duration is complete, in step 208 if another touch input is detected to the same sound screen area is detected by controller 110 When a touch occurs in the touch screen unit 160 while the relevant sound source is being reproduced by the default player in step 207, the controller 110 determines in steps 208 and 210 whether a second touch to the same sound screen area is detected. If yes, this constitutes detection of a multi-touch input.

If, on the other hand, the second touch is a touch of a different sound source area, the method proceeds to step 209, where the controller 110 requests the player manager 170 for the allocation of a player for reproducing a sound source corresponding to the different touched area related to another musical instrument. At the request as described above, under the control of the controller 110, the player manager 170 allocates a default player corresponding to the different touched area, and a relevant set sound source is reproduced by the default player corresponding to that touched area. At this time, step 209 is performed simultaneously with the continued reproduction of the sound source by the allocated default player in step 207.

When the multi-touch input has been detected in steps 208 and 210, the controller 110 in step 211 requests the player manager 170 for the allocation of a player for repeatedly reproducing a sound source corresponding to the same touch-selected area. (It is noted here that if the time period for reproduction had expired, i.e., if the reproduction in step 207 was completed, the process after query 210 reverts back to step 207 such that the second touch results in the same type of sound reproduction as occurred previously.)

In step 211, under the control of the controller 110, the player manager 170 acquires and allocates a second player (e.g. a player which may have been designated as a default player for other sound sources but is not performing a current reproduction operation), that can reproduce the same sound source. This is illustrated by the example in FIG. 3A, in which a multi-touch input is detected for sound group SG4 (or particularly for SS10, SS11 or SS12). PLAYER 4 is the designated default player used in step 207; PLAYER 8 is the allocated player (indicated by path AP) used in steps 211, 212.

With the second player allocated, the controller 110 proceeds to step 212. Here, under the control of the controller 110, while the sound source is being reproduced by the default player in step 207, the second player begins to reproduce the sound source being reproduced by the default player, so that the sound source is repeatedly reproduced. This operation is illustrated in FIG. 3C. PLAYER 4 (first player) begins reproduction of a sound S1 for a sound source of an area such as SS10, at time t1 (according to step 207). The sound S1 is designed to last for a duration T ending at time t2, and is output through the device 100 speaker via audio processor 125. Before time t2 is reached at time t1a, a second touch input is sensed at area SS10. In response, player manager allocates a second player, PLAYER 8, to reproduce sound S2 (the same sound as S1) beginning at time t1a, while sound S1 is still being output. Thus a sound effect is produced as though a second instrument is being played together with a first instrument. The reproduction of sound S1 ends at time t1 a while sound S2 is played until e.g., a time (t1a+T).

In step 213, when the repeated reproduction of the relevant sound source is completed by both the default player and the second player (e.g. at time t1A+T), the controller 110 notifies the player manager 170 of the completed reproduction. The process then proceeds to step 214 where the player manager 170 cancels the allocation of the second player allocated for the multiple reproductions.

In the embodiments described above, although the operation of two touches is explained as an example of the multi-touch operation, it is possible to repeatedly reproduce a relevant sound source, according to the number of times of multi-touch operations by the same number of allocable players. For instance, in the example above, if a user touch-selects the same area SS10 a third time before either time t2 expires, a third player can be allocated to play a third sound while sounds s1 and s2 are being reproduced. This operation would generate yet a further lingering sound effect.

Embodiments of the present invention can result in one or more of the following advantages: (i) it is possible to improve the performance of processing a sound source in a performance mode; (ii) it is possible to maintain the effect of reproducing a relevant sound source together with an actual spread thereof without ceasing an initial audio output of the relevant sound source, in response to a multi-touch detection of an identical musical instrument area; and (iii) it is possible to register and use desired sound sources without limitation in the number thereof.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the specific embodiments such as a portable terminal have been shown and described in the description of the present invention as described above, various changes in form and details may be made in the specific embodiments of the present invention without departing from the spirit and scope of the present invention. For instance, while implementations have been described in the context of a smart phone type portable terminal, implementations in other electronic devices are also possible, such as portable audio players with touch screens, laptops and tablet devices. Further, while a particular type of multi-touch operation has been described, other types are possible, such as a simultaneous multi-touch operation (e.g., at least two finger touch) to separated portions of the display screen within a touch screen area of an instrument such as SS10. Therefore, the spirit and scope of the present invention is not limited to the described embodiments thereof, but is defined by the appended claims and equivalents.

What is claimed is:

1. A method for processing a sound source, implemented in a touch screen electronic device, the method comprising:
displaying a representation of a sound source in a touch screen area;
reproducing the sound source via a first player among a predetermined number of players in the electronic device; and
detecting a multi-touch operation in the touch screen area, and in response, repeating the reproduction of the sound source via a second, allocated player, while the sound source is still being reproduced via the first player.

2. The method of claim 1, wherein the sound source is a first sound source and the method further comprising:
designating a default player for reproducing multiple sound sources, wherein the first player via which the first sound source is reproduced is the default player; and
setting the multiple sound sources as a group in such a manner that the multiple sound sources are matched with multiple small areas included in the touch screen area within which the representation of the sound source is displayed

3. The method of claim 1, wherein the multi-touch operation comprises a first touch operation followed by at least a second touch operation to the same touch screen area.

4. The method of claim 3, wherein the reproduction of the sound source via the first player is responsive to the first touch operation of the multi-touch operation and the reproduction of the sound source via the second player is responsive to the second touch operation of the multi-touch operation.

5. The method of claim 3 wherein the reproduction of the sound source via the first player is responsive to another touch operation distinct from the first and second touch operations of the multi-touch operation.

6. The method as claimed in claim 1, further comprising allocating a number of second players for reproducing the sound source according to a number of touch inputs caused by the multi-touch operation.

7. The method as claimed in claim 1, further comprising cancelling the allocation of the second player when the repeated reproduction of the relevant sound source according to the multi-touch has been completed.

8. The method as claimed in claim 2, further comprising:
determining whether there are touched small areas among multiple small areas included in the touch screen area, when the multi-touch operation to the touch screen area has occurred; and
repeatedly reproducing a relevant sound source corresponding to each of the touched small areas by the default player and the second player.

9. An apparatus for processing a sound source, the apparatus comprising:
a touch screen display displaying a representation of a sound source in a touch screen area;
a predetermined number of players for reproducing sound sources;
a player manager configured to allocate at least one second player capable of reproducing a relevant sound source among the predetermined number of players; and
a controller, responsive to a multi-touch operation to the touch screen area, controlling the at least one second player to repeat a reproduction of the sound source while the relevant sound source is reproduced by a first player.

10. The apparatus of claim 1, wherein the first player is a default player, and further comprising a memory for storing multiple sound sources reproduced in a performance mode, and
wherein the default player is assigned for the multiple sound sources.

11. The apparatus of claim 10, wherein the multiple sound sources are set as a group in such a manner that the multiple sound sources are matched with multiple small areas included in the touch screen area.

12. The apparatus of claim 9, wherein the player manager identifies information on sound sources, for which a relevant player among the predetermined number of players is designated as a default player.

13. The apparatus of claim 9, wherein the player manager cancels the allocation of the at least one second player excluding the first player when the multiple reproductions of the relevant sound source according to the multi-touch operation have been completed.

14. The apparatus of claim 9, wherein the controller determines whether there are relevant touched small areas among multiple small areas included in the touch screen area, when the multi-touch operation to the identical area has occurred in a performance mode, and performs a control operation for repeatedly reproducing a relevant sound source corresponding to each of the relevant touched small areas by the first player and the at least one second player.

15. A recording medium storing code which when executed by a processor causes a touch screen electronic device to:
display a representation of a sound source in a touch screen area;
reproduce the sound source via a first player among a predetermined number of players in the electronic device; and
detect a multi-touch operation in the touch screen area, and in response, repeat the reproduction of the sound source via a second, allocated player, while the sound source is still being reproduced via the first player.

16. The recording medium of claim 15, wherein the sound source is a first sound source and the processor further causes the electronic device to:
designate a default player for reproducing multiple sound sources, wherein the first player via which the first sound source is reproduced is the default player; and
set the multiple sound sources as a group in such a manner that the multiple sound sources are matched with multiple small areas included in the touch screen area within which the representation of the sound source is displayed

17. The recording medium of claim 15, wherein the multi-touch operation comprises a first touch operation followed by at least a second touch operation to the same touch screen area.

18. The recording medium of claim 17, wherein the reproduction of the sound source via the first player is responsive to the first touch operation of the multi-touch operation and the reproduction of the sound source via the second player is responsive to the second touch operation of the multi-touch operation.
